(19) United States
(12) Patent Application Publication
(10) Pub. No.: US 2025/0145821 A1
(43) Pub. Date: May 8, 2025

(54) OXYGEN SCAVENGING POLYMERS WITH IMPROVED HAZE CHARACTERISTICS

(71) Applicant: AURIGA POLYMERS, INC, Charlotte, NC (US)

(72) Inventor: Stephen Edward Lehman, JR., Spartanburg, SC (US)

(21) Appl. No.: 18/837,237

(22) PCT Filed: Mar. 15, 2023
(86) PCT No.: PCT/US2023/015265

§ 371 Date: Aug. 9, 2024

Related U.S. Application Data
(60) Provisional application No. 63/321,800, filed on Mar. 21, 2022.

(51) Int. Cl. C08L 71/02; B01J 23/75; C08G 63/672

(52) U.S. Cl. CPC C08L 71/02; B01J 23/75; C08G 63/672

(57) ABSTRACT

An oxygen scavenging composition that includes a polyester-poly(alkylene oxide) glycol copolymer, preferably containing 55 wt. % to about 58 wt. % polytetramethylene ether glycol (PTMEG) with an optional number average molecular weight of between about 1,000 g/mol to about 650 g/mol and blended with a polyethylene terephthalate copolymer, comprising polyethylene terephthalate and a transition metal oxidation catalyst, including methods for manufacturing the oxygen scavenging composition and articles made therefrom.

### FIELD OF THE INVENTION

The present invention relates to oxygen scavenging compositions used in plastic packaging having enhanced haze properties, and more generally relates to an improved oxygen scavenging polymer that includes a polyester and a poly(alkylene oxide) glycol that when blended with a polyethylene terephthalate copolymer that includes polyethylene terephthalate and a transition metal oxidation catalyst reduces the increase in haze over time and effectively consumes oxygen and a method of manufacturing thereof.

### BACKGROUND OF THE INVENTION

Typical polymers used in making articles, such as sheets and thermoformed trays are primarily based on polyester due to its physical properties. Suitable polyesters can be homopolymers such as polyethylene terephthalate (PET), polyethylene naphthalate (PEN), or copolymers of either or both.

Oxygen scavenging polymers are well known and are especially useful in the food packaging business. It is known that oxygen can have an effect on the odor and taste of packaged food thereby shortening the shelf life of food. Oxygen scavenging packaging materials, on the other hand, react with oxygen that is in the process of traversing the packaging barrier. Thus the oxygen scavenging packaging material reduces or eliminates the odor and/or undesirable taste of food or beverages excessively exposed to oxygen.

Typical oxygen scavenging compounds are oxidizable organic polymer molecules containing allylic positions such as polybutadiene based polymers, or polyethylene/cyclohexene copolymers, or containing benzylic positions such as m-xylylamine-based polyamides, or mixtures of these. The use of oxidizable organic polymers by themselves results in a very slow oxidative process. The incorporation of oxidation catalyst into the oxidizable polymer solves this problem.

Polytetramethylene ether glycol (PTMEG) is a high volume commercial product. PTMEG has a number average molecular weight of from 600 to 2,200 is widely used in the formation of block copolymers used as soft (elastomeric) segments in polyurethanes or polyesters such as polybutylene terephthalate. The block copolymers with polyesters are used to form injection moldable elastomers having a wide variety of uses, often industrial or automotive.

PTMEG is generally made commercially by polymerizing tetrahydrofuran (TIF) using fluorosulfonic acid as the catalyst. In the reaction the sulfate ester of PTMEG is formed which is hydrolyzed to produced PTMEG and sulfuric and hydrofluoric acids. About 95-98 wt % of these acids are washed out of the product with water. The residual quantity of acids in the finished product is neutralized with calcium hydroxide. The solids are then filtered, and the PTMEG product is dried.

The molecular weight of PTMEG significantly influences the physical properties of both the PTMEG and the products derived from it. For example, PTMEG of relatively low molecular weight is a sticky, viscous oil at room temperature while, at higher molecular weights, it is thicker and waxier. As is true of all polymeric compounds, the molecular weight of PTMEG may be expressed as either a “number-average” or a “weight-average”. The number average molecular weight (Mn) is obtained by dividing the weight of a sample by the number of molecules of which it is composed. The weight-average molecular weight (Mw), on the other hand, is defined as the ratio of the sum of the mathematical products obtained by multiplying each molecular weight present in the sample by its corresponding fractional weight and the total sample weight. In practice, Mn and Mw are normally determined via such methods as gel permeation chromatography (GPC). Since a typical sample of PTMEG is composed of molecules of different degrees of polymerization, a distribution of molecular weights exists and as a result, values of Mn and Mw are not equivalent. The ratio Mw/Mn, referred to as the polydispersity, is indicative of the breadth of distribution of molecular weights for a given sample of polymer.

It is known to employ a polyester, such as polyethylene terephthalate (PET), PTMEG copolymer that functions as an oxygen scavenger when blended with a polyester, such as polyethylene terephthalate in the presence of cobalt or another oxidation catalyst. However, these compositions when formed into sheets or thermoformed trays experience an unacceptable increase in haze over a period of time. These articles develop haze slowly over time in ambient storage conditions and this increase in haze is not acceptable to consumers. Therefore, an oxygen scavenging composition that when formed into an article, such as a sheet or thermoformed tray, that has improved haze characteristics is needed.

U.S. Pat. No. 6,445,620 discloses a polyester, PTMEG, and oxidation catalyst oxygen scavenging composition.

U.S. Pat. No. 9,340,316 discloses an oxygen-scavenging multi-layer container that includes an outer layer, an inner layer, and at least one middle layer interposed between the outer layer and the inner layer. The middle layer includes a blend of at least one oxygen scavenging component, at least one catalyst-containing concentrate, and a polymer consisting essentially of polyethylene terephthalate (PET), and at least one transition metal catalyst up to about 3% by weight. The outer layer and the inner layer consist essentially of amorphous polyethylene terephthalate (APET).

U.S. Pat. No. 9,370,913 discloses an oxygen-scavenging multi-layer container that includes an outer layer, an inner layer, and at least one middle layer interposed between the outer layer and the inner layer. The middle layer includes a blend of at least one oxygen scavenging component, at least one catalyst-containing concentrate, and a polymer consisting essentially of polyethylene terephthalate (PET), and at least one transition metal catalyst up to about 3% by weight. The outer layer and t consists essentially of crystalline polyethylene terephthalate (CPET).

EP 2 183 318 discloses a composition comprising a polyester, a copolyester ether and an oxidation catalyst, wherein the copolyester ether comprises a polyether segment comprising poly(tetramethylene-co-alkylene ether).

### BRIEF SUMMARY OF THE INVENTION

According to an embodiment of the present invention, an oxygen scavenging composition includes a polyester and a poly(alkylene oxide) glycol, wherein the polyester is preferably polyethylene terephthalate and the poly(alkylene oxide) glycol is preferably polytetramethylene ether glycol (PTMEG).

According to yet another embodiment of the present invention, the oxygen scavenging composition includes between about 55 wt. % to about 58 wt. % polytetramethylene ether glycol (PTMEG) with an optional number average molecular weight of 1,000 g/mol to about 650 g/mol.

According to yet another embodiment of the present invention, an oxygen scavenging composition includes a polyester and a poly(alkylene oxide) glycol, wherein the polyester is preferably polyethylene terephthalate and the poly(alkylene oxide) glycol is preferably polytetramethylene ether glycol (PTMEG), blended with a polyethylene terephthalate copolymer, comprising polyethylene terephthalate and a transition metal oxidation catalyst.

A method of producing an oxygen scavenging composition that includes polymerizing a polytetramethylene ether glycol (PTMEG) with a polyethylene terephthalate monomer (PET) forming a PET-PTMEG copolymer, and blending the oxygen scavenging composition with a polyethylene terephthalate copolymer that includes a polyethylene terephthalate and a transition metal oxidation catalyst.

A method of producing an article from an oxygen scavenging composition that includes providing an extruder, polymerizing a polytetramethylene ether glycol (PTMEG) with a polyethylene terephthalate monomer (PET) forming a PET-PTMEG copolymer, blending the PET-PTMEG copolymer with a polyethylene terephthalate copolymer that includes polyethylene terephthalate and a polymer masterbatch that contains a transition metal oxidation catalyst forming an oxygen scavenging composition, and feeding the oxygen scavenging composition to the extruder, forming a sheet.

### DETAILED DESCRIPTION OF THE INVENTION

The present invention may be understood more readily by reference to the following detailed description of the invention. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

The ranges set forth herein include both numbers at the end of each range and any conceivable number there between, as that is the very definition of a range. It is therefore to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5 as examples.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

As used herein, the terms “comprise”, “comprises”, “containing”; and “has”, “have”, “having”; and “includes”, “include” and “including”; are open-ended transition terms used to transition from a subject recited before the term to one or more elements recited after the term, where the element or elements listed after the transition term are not necessarily the only elements that make up the subject.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching comonomers. Typically, the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching comonomers.

The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, and/or mixtures thereof. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

The term weight percent or wt. % means the weight of a given raw material relative to the weight of the resulting composition which includes the raw material. For example, a composition having 55 wt. % of polytetramethylene ether glycol (PTMEG) means that the composition includes 55 parts by weight of the polytetramethylene ether glycol (PTMEG) raw material relative to 100 parts of the total weight of the resulting composition. It is understood that the PTMEG residues in the resulting composition differ chemically from the raw material in that the PTMEG residues in the resulting composition lack the functional groups at the ends of the PTMEG chains. The ends of the PTMEG chains are bonded as ester groups to terephthalate units.

### Polyester

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and glycol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 5 mole % isophthalic acid, based on the total acid residues, means the polyester contains 5 mole % isophthalic acid residues out of a total of 100 mole % acid residues. Thus, there is 5 mole of isophthalic acid residues among every 100 moles of acid residues. In another example, polyester containing 1.5 mole % diethylene glycol, out of a total of 100 mole % glycol residues, has 1.5 moles of diethylene glycol residues among every 100 moles of glycol residues.

The polyester polymer of the invention contains ethylene terephthalate repeat units in the polymer chain. The polyester polymer comprises:
(a) a carboxylic acid component comprising at least 90 mole percent, at least 92 mole percent, at least 93 mole percent, or at least 96 mole percent of the residues of terephthalic acid or derivatives of terephthalic acid, or mixtures thereof, and
(b) a diol component comprising at least 90 mole percent, at least 92 mole percent, at least 93 mole percent, or at least 96 mole percent of the residues of ethylene glycol,
   based on 100 mole percent of carboxylic acid component residues and 100 mole percent of hydroxyl component residues in the polyester polymer.

Polyester resins can optionally be modified by up to 10 wt. % of dicarboxylic acids other than terephthalic acid are useful in forming the resins of this invention. Suitable diacids can be aliphatic, alicyclic, or aromatic dicarboxylic acids such as isophthalic acid, 1,4-cyclohexanedicarboxylic acid; 1,3-cyclohexanedicarboxylic acid, succinic acid, glutaric acid, adipic acid, sebacic acid, 1,12-dodecanedioic acid; 2,6-naphthalenedicarboxylic acid, bibenzoic acid, oxalic acid, malonic acid, pimelic acid, suberic acid, azelaic acid, maleic acid, fumaric acid, phthalic acid, hemimellitic acid, trimellitic acid, trimesic acid, or mixtures of these and their equivalents. It is often suitable to use a functional acid derivative equivalent such as dimethyl, diethyl, or dipropyl ester of the dicarboxylic acid. The preferred modifying dicarboxylic acid is isophthalic acid or 2,6-naphthalenedicarboxylic acid.

Alternatively, polyester resins can optionally be modified by up to 10 wt. % of one or more different diols than ethylene glycol. In a typical PET process about 2 mole percent of diethylene glycol is formed by the esterification of ethylene glycol. Such additional diols include cycloaliphatic diols for example having 6 to 20 carbon atoms or aliphatic diols preferably having 3 to 20 carbon atoms. Examples of such diols to be included with ethylene glycol are: diethylene glycol, triethylene glycol, 1,2-cyclohexanedimethanol, 1,3-cyclohexanedimethanol, 1,4-cyclohexanedimethanol, propane-1,3-diol, butane-1,4-diol, pentane-1,5-diol, hexane-1,6-diol, 2-methyl-1,3-pentanediol, 2,2-dimethyl-1,3-pentanediol, 2,2,4-trimethylpentane-diol-(1,3), 2-ethylhexanediol-(1,3), 2,2-diethylpropane-diol-(1,3), hexanediol-(1,3), 1,4-di-(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, and 2,2-bis-(4 hydroxypropoxyphenyl)-propane. The preferred modifying diols are diethylene glycol, 1,4-cyclohexanedimethanol, 2-methyl-1,3-pentanediol and 2,2-dimethyl-1,3-pentanediol.

The polyesters of the invention can also comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 to about 5% by weight, or about 0.1 to about 2% by weight, based on the total weight of the polyester.

In addition, the polyester compositions and the polymer blend compositions useful in the invention may also contain any amount of at least one additive, for example, from 0.01 to 2.5% by weight of the overall composition common additives such as colorants, dyes, mold release agents, flame retardants, plasticizers, stabilizers, including but not limited to, UV stabilizers, thermo-oxidative stabilizers and/or reaction products thereof, chain extenders and impact modifiers. Examples of thermo-oxidative stabilizers include phosphorus compounds and primary and secondary antioxidants commercially available for use in polyester resins. Examples of typical commercially available impact modifiers well known in the art and useful in this invention include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Examples of chain extenders include, but are not limited to, multifunctional (including, but not limited to, bifunctional) isocyanates, multifunctional epoxides, including for example, epoxylated novolacs, and phenoxy resins. Residues of such additives are also contemplated as part of the polyester composition.

In addition, certain agents which tone the polymer can be added to the polycondensation process. A bluing toner can be used to reduce the yellowness of the resulting polyester polymer melt phase product. Such bluing agents include cobalt salts, blue inorganic and organic toner(s) and the like. In addition, red toner(s) can also be used to adjust the redness. Organic toner(s), e.g., blue and red organic toner(s) can be used. The organic toner(s) can be fed as a premix composition. The premix composition may be a neat blend of the red and blue compounds or the composition may be dissolved or slurried in one of the polyester's raw materials, e.g., ethylene glycol.

The total amount of added toner components depends on the amount of inherent yellow color in the base polyester and the efficacy of the toner. Generally, a concentration of up to about 15 ppm of combined organic toner components and a minimum concentration of about 0.5 ppm are used, with the total amount of bluing additive typically ranging from about 0.5 ppm to about 10 ppm.

### Polymerization Process

Polyesters of the present invention are manufactured by a continuous process. A continuous process typically consists of four main process units, (i) slurry preparation vessel in which the dicarboxylic acid and diol are mixed, (ii) esterification unit, (iii) prepolymerization (or low polymerization) unit, and (iv) high polymerizer or finisher unit. In most designs the melt phase polymerization is conducted in one or more esterification reactors, one or more prepolymerizer and one or two high polymerizers. In some designs the esterification and prepolymerization is conducted in one vessel.

The terms “esterifier”, “prepolymerizer”, “high polymerizer” or “finisher” as used in this description and claims are intended to mean both single and multiple reactors in each unit. A typical polyesterification process is comprised of one or more stages and commercially carried out in one of two common pathways. For a process, which employs direct esterification in the initial stage of the process, the dicarboxylic acids react with one or more diols at a temperature of about 200° C. to about 250° C. to form macro-monomeric structures and a small condensate molecule, water. Because the reaction is reversible, the water is continuously removed to drive the reaction to the desired first stage product. In a like manner, when using diesters (versus diacids), an ester interchange process is used to react the ester groups of the diesters and diols with certain well known catalysts, such as manganese acetate, zinc acetate, or cobalt acetate. After completing the ester interchange reaction these catalysts are sequestered with a phosphorus compound, such as phosphoric acid, to prevent degradation during the polycondensation process.

Next, in the second stage of the reaction, either macro-monomeric structures (direct esterification products) or interchanged moieties (ester interchange products), commonly described as oligomeric esterification products, undergo a polycondensation reaction to form the polymer.

The reactants from the esterification stage are then continuously transferred to a prepolymerizer which has a slight vacuum, preferably less than about 200 mm mercury absolute, and operates in the range of approximately 240 to 300° C. for approximately 30 to 75 minutes. This prepolymerizer can be an integral part of the esterification process. At this stage the prepolymer has a molecular weight, as measured by its Intrinsic Viscosity (IV), in the range of about 0.2 to about 0.3 dl/g. This prepolymer is then continuously transferred to an intermediate polymerizer, or directly to a high polymerizer where the vacuum is increased to less than about 10 millimeter mercury absolute, preferably less than about 5 mm, and the temperature is between approximately 260 and 300°. C. for approximately 45 minutes to 90 minutes. The diol is continuously removed in the prepolymerizer and high polymerizers, and recycled back to the esterifier.

This polymerization reaction is stopped when the required/targeted molecular weight is achieved and/or the maximum molecular weight of the design of the equipment is reached. The polyester may extruded through a die into strands which are quenched and cut into pellets, or cut under-water to form pellets. If necessary, the polyester pellets can be further polymerized to a higher molecular weight by well-known solid state polymerization processing techniques. The preferred polyester utilized in this invention is polyethylene terephthalate (PET), and as shown in the Examples below, the polyethylene terephthalate (PET) is utilized in its molten state and referred to as the PET monomer.

The catalysts generally used for the polycondensation reaction are compounds containing antimony, germanium, aluminum, titanium or other catalysts known to those skilled in the art, or mixtures thereof. The specific additives used and the point of introduction during the reaction is known in the art and does not form a part of the present invention. Any conventional system may be employed and those skilled in the art can select among various commercially-available systems for the introduction of additives so as to achieve an optimal result.

As noted in the discussion of the prior art, all current oxygen scavenging polymers suffer from an increase in haze when formed into films and thermoform trays, which makes them unacceptable for certain uses. In such blends either colorants are added may be added to mask the haze, or only a low amount of the oxygen scavenging polymer can be utilized to limit the increase in haze, with the consequent limit on oxygen scavenging capacity.

### Poly(Alkylene Oxide) Glycols

After extensive research, the inventor discovered that by polymerizing a higher percentage of poly(alkylene oxide) glycols to produce a copolymer with the polyester, preferably PET, the resultant copolymer after blending with a PET copolymer and formed into an article, such as a sheet or thermoformed tray, had high oxygen scavenging capacity and a reduction in the increase in haze. More specifically, the inventor discovered that by increasing the amount of poly(alkylene oxide) glycols and optionally decreasing the molecular weight of the poly(alkylene oxide) glycol to produce a copolymer with the polyester, preferably PET, there was a reduction in the increase in haze when blended with PET copolymers, containing PET and a cobalt oxidation catalyst in sufficient quantity to catalyze oxygen scavenging, and formed into a sheet or thermoformed tray.

Examples of poly(alkylene oxide) glycols include poly(ethylene oxide) glycol, poly(1,2 and 1,3-propylene oxide) glycol, polytetramethylene ether glycol (PTMEG), poly(pentamethylene oxide) glycol, poly(hexamethylene oxide) glycol, poly(heptamethylene oxide) glycol, poly(octamethylene oxide) glycol, poly(nonamethylene oxide) glycol, poly(decamethylene oxide) glycol and random or block copolymer glycols of the above alkylene oxides. The preferred poly(alkylene oxide) glycol is polytetramethylene ether glycol, referred to herein as PTMEG.

Poly(alkylene oxide) glycol having number average molecular weight in the range of about 2,000 g/mol to about 200 g/mole is preferred. The most preferred range of poly(alkylene oxide) glycol molecular weight is about 1,400 g/mol to about 650 g/mole. As a mole percent of the diols in these oxygen scavenging polyesters, the poly(alkylene oxide) glycol is preferably in the range of about 56% to about 58%. The use of Poly(alkylene oxide) glycol outside this range did not provide an oxygen scavenging copolyester with the optimum balance of oxygen permeability and a reduction in the increase in haze. It has been found that the use of poly(alkylene oxide) glycols, such as PTMEG, 50% and below have an unacceptably high increase in haze and/or inferior oxygen scavenging capability depending upon the number average molecular weight of the PTMEG. The use of poly(alkylene oxide) glycols, such as PTMEG, 70% and above have a significantly higher initial haze that is also unacceptable.

The oxygen scavenging composition is prepared by the polymerization of poly(alkylene oxide) with a polyester, and specifically a PET monomer with PTMEG. Preferably, the oxygen scavenging composition is prepared by the polymerization of between about 56% to about 58% PTMEG with the PET monomer. The number average molecular weight of the PTMEG may optionally be between about 1,400 g/mol to about 650 g/mol, and preferably between about 1,000 g/mol to about 650 g/mol. The oxygen scavenging composition may be further blended with a PET copolymer, containing PET and a transition metal catalyst, wherein the transition metal catalyst improves the oxygen scavenging efficiency in the resultant copolyester for forming a sheet or thermoformed tray. A cobalt compound is preferred as the transition metal catalyst. The cobalt transition metal catalyst contemplated herein is not the other transition metal catalyst that may be used in the manufacturing of the polyester in the oxygen scavenging composition. Suitable cobalt compounds for use with the present invention include cobalt acetate, cobalt carbonate, cobalt chloride, cobalt hydroxide, cobalt naphthenate, cobalt oleate, cobalt linoleate, cobalt octoate, cobalt stearate, cobalt nitrate, cobalt phosphate, cobalt sulfate, cobalt (ethylene glycolate), and mixtures of two or more of these, among others. Preferably, the cobalt compound is incorporated into a PET copolymer that is blended with the oxygen scavenging composition to form an article, such as a sheet or thermoformed tray. A suitable PET copolymer is commercial PET type 2512—that contains a cobalt oxidation catalyst in sufficient quantities to catalyze oxygen scavenging and available from Auriga Polymers, Inc., Spartanburg, South Carolina. Referred to herein as PET type 2512.

### Test Procedures

### Oxygen Scavenging

There are several methods available to determine oxygen scavenging. In this case, a non-invasive oxygen measurement system supplied by PreSense Precision Sensing of Regensburg, Germany based on a fluorescence quenching method for sealed containers was employed. The system consists of an optical system with an oxygen sensor spot, which is a metal organic fluorescent dye immobilized in a gas permeable hydrophobic polymer and a fiber optic reader-pen assembly which contains both a blue LED and photo-detector to measure the fluorescence lifetime characteristics of the oxygen sensor spot.

The oxygen measurement technique is based upon the absorption of light in the blue region of the metal organic fluorescent dye of the oxygen sensor spot, and fluorescence within the red region of the spectrum. The presence of oxygen quenches the fluorescent light from the dye as well as reducing its lifetime. These changes in the fluorescence emission intensity and lifetime are related to the oxygen partial pressure, and thus they can be calibrated to determine the corresponding oxygen concentration.

The oxygen level within an enclosed container such as a jar can be measured by attaching an oxygen sensor spot inside the package. The oxygen sensor spot is then illuminated with a pulsed blue light from the LED of the fiber optic reader-pen assembly. The incident blue light is first absorbed by the dot and then a red fluorescence light is emitted. The red light is detected by a photo-detector and the characteristic of the fluorescence lifetime is measured. Different lifetime characteristics indicate different levels of oxygen within the package.

A PreSens (Regensburg, Germany) non-invasive and non-destructive oxygen ingress measurement equipment (Fibox 4 oxygen sensor instrument) was used to determine oxygen permeability of plastic sheet samples at ambient conditions (23° C.). The plastic sheet samples weighing 20 g were cut into 1 cm squares and added to a 4 oz glass jar that has a PreSens fluorescent dot sensor adhered to the inside wall. Oxygenated water containing biocide was prepared in a steel carboy by bubbling air through the fluid and was then transferred to the jar containing the sheet pieces until the jar was brimful. A sealing lid was used to close the jar tightly. The jars were stored at ambient conditions (23° C.) during the test period. The oxygen concentration in the water was then measured periodically to the track the consumption of oxygen by the plastic sheet as a function of time using the PreSens oxygen sensor instrument. Testing was carried out for 21 d.

### Intrinsic Viscosity

IV of the polyester resins was measured according to ASTM D4603-96.

### Haze

The haze of sheet samples was measured with a Hunter Lab ColorQuest II instrument. D65 illuminant was used with a CIE 1964 10° standard observer. The haze is defined as the percent of the CIE Y diffuse transmittance to the CIE Y total transmission. The color of the sheet was measured with the same instrument and is reported using the CIELAB color scale, L* is a measure of brightness, a* is a measure of redness (+) or greenness (−) and b* is a measure of yellowness (+) or blueness (−).

### DEG Content

The DEG (diethylene glycol) content of the polymer is determined by hydrolyzing the polymer with an aqueous solution of ammonium hydroxide in a sealed reaction vessel at 220+5° C. for approximately two hours. The liquid portion of the hydrolyzed product is then analyzed by gas chromatography. The gas chromatography apparatus is a FID Detector (HP5890, HP7673A) from Hewlett Packard. The ammonium hydroxide is 28 to 30% by weight ammonium hydroxide from Fisher Scientific and is reagent grade.

### Melting Point

The melting point of the polyesters was taken as the peak of the melting endotherm of the copolyester as measured in accordance with ASTM D 3418-03. The sample was heated from 30 to 300° C. at a rate of 10° C./min, held for 5 minutes and rapidly quenched to 10° C. (at an approximate rate of 320° C./sec). The sample was then heated at 10° C./min to 300° C. and the peak melting endotherm temperature recorded.

### EXAMPLES

All examples below employ a PET monomer (“the PET monomer”) derived as described above from a plant central monomer delivery system. This system is a continuous production system where purified terephthalic acid and ethylene glycol are reacted together at a molar ratio of 1.02 to 1.20 (EG:PTA) at a temperature of 260° C. and pressure of 1000 mbar to produce a molten liquid PET monomer with 200-500 meq/kg carboxyl end group content. This reaction is advanced by distilling water from the reaction mixture through a distillation column.

### Comparative Example 1

An oxygen scavenging composition was prepared at 15 kg scale by polymerization of 50% PTMEG with number average molecular weight 1400 g/mol with the PET monomer. Specifically, 8.0 kg of the PET monomer was charged to a stainless steel pilot vessel fitted with a distillation column/condenser, agitator, vacuum source (via stem ejectors), vents, and inlet ports. The vessel was then charged with 2.0 kg EG, and the contents heated to 240° C. for 1 hr. The vessel was then charged with 7.5 kg PTMEG with number average molecular weight 1400 g/mol (Terathane® obtained from the LYCRA Company, Wilmington, DE), 21 g Tyzor AC422 catalyst (obtained from Dorf Ketal, Stafford TX), and 1.5 g Ethanox 330 (obtained from Albemarle Europe SPRL Belgium). EG (0.5 kg) was used to rinse any residue remaining on the addition port into the vessel. The contents were then heated to 250° C. at which point a vacuum let down program was begun to decrease the pressure in the vessel from ambient to <1 torr over 45 min. This is accomplished by slowly closing a valve that spoils the vacuum source with a nitrogen gas supply. The contents are then polymerized at 250° C. and <1 torr until an agitator torque indication of 600 in-lbs is reached or 4 hr is elapsed from the start of the vacuum let down. At this point the polymerization is ceased by filling the vessel with nitrogen. A bottom drain valve is opened and the polymer is extruded by applying nitrogen pressure to the vessel and the extruded polymer noodle is quenched in an ice/water trough and granulated with a strand cutter.

### Example 1

In the manner of Comparative Example 1, an oxygen scavenging composition of the invention was prepared by polymerization of 55% PTMEG with a number average molecular weight of 650 g/mol with the PET monomer. Deviating from Comparative Example 1 for the purposes of Example 1, the amount of the PET monomer charged is 7.7 kg, the amount of EG charged is 1.9 kg, the amount of PTMEG charged is 8.3 kg, and the PTMEG has a number average molecular weight of 650 g/mol (PTMEG 650 obtained from Gantrade Montvale, NJ).

### Example 2

In the manner of Comparative Example 1, an oxygen scavenging composition of the invention was prepared by polymerization of 70% PTMEG with a number average molecular weight of 650 g/mol with the PET monomer. Deviating from Comparative Example 1 for the purposes of Example 2, the amount of the PET monomer charged is 6.0 kg, the amount of EG charged is 1.4 kg, the amount of PTMEG charged is 10.5 kg, and the PTMEG has a number average molecular weight of 650 g/mol (PTMEG 650 obtained from Gantrade Montvale, NJ).

### Example 3

In the manner of Comparative Example 1, an oxygen scavenging composition of the invention was prepared by polymerization of 58% PTMEG with a number average molecular weight of 1400 g/mol with the PET monomer. Deviating from Comparative Example 1 for the purposes of Example 3, the amount of the PET monomer charged is 6.8 kg, the amount of EG charged is 1.7 kg, the amount of PTMEG charged is 8.7 kg, and the PTMEG has a number average molecular weight of 1400 g/mol (Terathane® obtained from the LYCRA Company, Wilmington, DE).

### Example 4

In the manner of Comparative Example 1, an oxygen scavenging composition of the invention was prepared by polymerization of 58% PTMEG with a number average molecular weight of 1000 g/mol with the PET monomer. Deviating from Comparative Example 1 for the purposes of Example 4, the amount of the PET monomer charged is 7.0 kg, the amount of EG charged is 1.8 kg, the amount of PTMEG charged is 8.7 kg, and the PTMEG has a number average molecular weight of 1000 g/mol (PTMEG 1000 obtained from Gantrade Montvale, NJ).

### Example 5

In the manner of Comparative Example 1, an oxygen scavenging composition of the invention was prepared by polymerization of 40% PTMEG with a number average molecular weight of 1000 g/mol with the PET monomer. Deviating from Comparative Example 1 for the purposes of Example 5, the amount of the PET monomer charged is 9.5 kg, the amount of EG charged is 2.4 kg, the amount of PTMEG charged is 6.0 kg, and the PTMEG has a number average molecular weight of 1000 g/mol (PTMEG 1000 obtained from Gantrade Montvale, NJ).

### Example 6

In the manner of Comparative Example 1, an oxygen scavenging composition of the invention was prepared by polymerization of 40% PTMEG with a number average molecular weight of 650 g/mol with the PET monomer. Deviating from Comparative Example 1 for the purposes of Example 6, the amount of the PET monomer charged is 9.7 kg, the amount of EG charged is 2.5 kg, the amount of PTMEG charged is 6.0 kg, and the PTMEG has a number average molecular weight of 650 g/mol (PTMEG 650 obtained from Gantrade Montvale, NJ).

### Example 7

In the manner of Comparative Example 1, an oxygen scavenging composition of the invention was prepared by polymerization of 50% PTMEG with a number average molecular weight of 1000 g/mol with the PET monomer. Deviating from Comparative Example 1 for the purposes of Example 7, the amount of the PET monomer charged is 8.1 kg, the amount of EG charged is 2.1 kg, the amount of PTMEG charged is 7.5 kg, and the PTMEG has a number average molecular weight of 1000 g/mol (PTMEG 1000 obtained from Gantrade Montvale, NJ).

### Table 1

Table 1 shows the properties of oxygen scavenging compositions of Comparative Example 1 and Examples 1-7.

TABLE 1

| | PTMEG | | | | | | | |
|---|---|---|---|---|---|---|---|---|
| | Loading | PTMEG | | | DEG | | | |
| | (% | Mn | IV | Tm | (% | CEG | | |
| | w/w) | (g/mol) | (dL/g) | (° C.) | w/w) | (meq/kg) | L* | b* |
| Comparative | 50 | 1400 | 1.2 | 234 | 0.6 | 15 | 62.1 | 18.7 |
| Example 1 | | | | | | | | |
| Example 1 | 55 | 650 | 1.3 | n/d | 0.3 | 10 | 60.2 | 15.4 |
| Example 2 | 70 | 650 | 1.3 | n/d | 0.1 | 9 | 62.9 | 16.0 |
| Example 3 | 58 | 1400 | 1.0 | 216 | 0.2 | 11 | 65.0 | 25.0 |
| Example 4 | 58 | 1000 | 1.3 | 204 | 0.3 | 9 | 61.5 | 23.6 |
| Example 5 | 38 | 1000 | 1.1 | 230 | 0.5 | 16 | n/a | n/a |
| Example 6 | 35 | 650 | 1.0 | 220 | n/a | 13 | n/a | n/a |
| Example 7 | 49 | 1000 | 1.1 | 215 | 0.3 | 7 | 64.1 | 26.5 |

(n/d indicates that no Tm was detected in DSC analysis, n/a indicates that data is not available)

### Comparative Example 2

The oxygen scavenging composition of Comparative Example 1 was blended at 1.5% (w/w) with commercial PET type 2512 (Indorama Ventures Ltd.) and extruded to 4″ wide sheet format in a Haake twin screw extruder with a sheet roll take off system. The sheet was 350 microns thick. The extrusion was run at 275° C. barrel and die temperature. The haze of sheet samples was measured periodically for 15 weeks. The measurement was taken at the middle of the sheet.

### Example 8

The oxygen scavenging composition of Example 1 was blended at 1.5% (w/w) with commercial PET type 2512 (Indorama Ventures Ltd.) and extruded to 4″ wide sheet format in a Haake twin screw extruder with a sheet roll take off system. The sheet was 350 microns thick. The extrusion was run at 275° C. barrel and die temperature. The haze of sheet samples was measured periodically for 15 weeks at the middle of the sheet.

### Example 9

The oxygen scavenging composition of Example 2 was blended at 1.5% (w/w) with commercial PET type 2512 (Indorama Ventures Ltd.) and extruded to 4″ wide sheet format in a Haake twin screw extruder with a sheet roll take off system. The sheet was 350 microns thick. The extrusion was run at 275° C. barrel and die temperature. The haze of sheet samples was measured periodically for 15 weeks at the middle of the sheet.

### Example 10

The oxygen scavenging composition of Example 3 was blended at 1.5% (w/w) with commercial PET type 2512 (Indorama Ventures Ltd.) and extruded to 4″ wide sheet format in a Haake twin screw extruder with a sheet roll take off system. The sheet was 350 microns thick. The extrusion was run at 275° C. barrel and die temperature. The haze of sheet samples was measured periodically for 15 weeks at the middle of the sheet.

### Example 11

The oxygen scavenging composition of Example 4 was blended at 1.5% (w/w) with commercial PET type 2512 (Indorama Ventures Ltd.) and extruded to 4″ wide sheet format in a Haake twin screw extruder with a sheet roll take off system. The sheet was 350 microns thick. The extrusion was run at 275° C. barrel and die temperature. The haze of sheet samples was measured periodically for 15 weeks at the middle of the sheet.

### Example 12

The oxygen scavenging composition of Example 5 was blended at 1.5% (w/w) with commercial PET type 2512 (Indorama Ventures Ltd.) and extruded to 4″ wide sheet format in a Haake twin screw extruder with a sheet roll take off system. The sheet was 350 microns thick. The extrusion was run at 275° C. barrel and die temperature. The haze of sheet samples was measured periodically for 15 weeks at the middle of the sheet.

### Example 13

The oxygen scavenging composition of Example 6 was blended at 1.5% (w/w) with commercial PET type 2512 (Indorama Ventures Ltd.) and extruded to 4″ wide sheet format in a Haake twin screw extruder with a sheet roll take off system. The sheet was 350 microns thick. The extrusion was run at 275° C. barrel and die temperature. The haze of sheet samples was measured periodically for 15 weeks at the middle of the sheet.

### Example 14

The oxygen scavenging composition of Example 7 was blended at 1.5% (w/w) with commercial PET type 2512 (Indorama Ventures Ltd.) and extruded to 4″ wide sheet format in a Haake twin screw extruder with a sheet roll take off system. The sheet was 350 microns thick. The extrusion was run at 275° C. barrel and die temperature. The haze of sheet samples was measured periodically for 15 weeks at the middle of the sheet.

### Comparative Example 3

PET type 2512 (without blending with any oxygen scavenging component) was extruded to 4″ wide sheet format in a Haake twin screw extruder with a sheet roll take off system. The sheet was 350 microns thick. The extrusion was run at 275° C. barrel and die temperature. The haze of sheet samples was measured periodically for 15 weeks at the middle of the sheet.

The polyethylene terephthalate copolymer containing polyethylene terephthalate and a transition metal oxidation catalyst used in these examples was commercial PET type 2512 that contains a cobalt oxidation catalyst in sufficient quantity (60 ppm Co element) to catalyze oxygen scavenging. Table 5 shows the percent of initial oxygen present in 4 oz of water that was able to be scavenged by the sheet samples in 21 days, with above 85% of oxygen being scavenged considered a positive result. Table 5 further shows that oxygen scavenging compositions of Comparative Example 1 and Examples 1-4 and 7 are able to scavenge oxygen well at 1.5% (w/w) concentration in sheet format. Examples 5 and 6, however, do not meet oxygen scavenging requirements due to the lower PTMEG loading in Examples 5 and 6 (38 and 35% PTMEG, respectively). Comparative Example 3 has no oxygen scavenging component so is not expected to scavenge oxygen.

The color of the sheet was measured with Hunter Lab ColorQuest II instrument and Tables 2, 3, and 4 show the results using the CIELAB color scale, where L* is a measure of brightness, a* is a measure of redness (+) or greenness (−) and b* is a measure of yellowness (+) or blueness (−).

TABLE 2

| Example | Sheet L* at Age (wk) | | | | | | |
|---|---|---|---|---|---|---|---|
| (weeks) | 2.0 | 4.0 | 6.0 | 8.0 | 10.0 | 15.0 | Change |
| Comparative | 94.1 | 93.5 | 93.2 | 92.2 | 91.5 | 89.4 | −4.7 |
| Example 2 | | | | | | | |
| Comparative | 96.3 | 96.3 | 96.3 | 96.3 | 96.5 | 96.4 | +0.1 |
| Example 3 | | | | | | | |
| Example 8 | 94.4 | 94.7 | 94.7 | 94.4 | 93.9 | 93.5 | −0.9 |
| Example 9 | 95.4 | 95.4 | 95.4 | 95.4 | 95.1 | 92.5 | −2.9 |
| Example 10 | 94.5 | 94.7 | 94.8 | 94.9 | 94.7 | 94.3 | −0.2 |
| Example 11 | 94.8 | 94.8 | 95.0 | 95.1 | 95.1 | 95.2 | +0.2 |
| Example 12 | 95.5 | 95.4 | 95.4 | 95.7 | 95.6 | 95.2 | −0.3 |
| Example 13 | 95.8 | 95.7 | 95.6 | 95.7 | 95.7 | 95.7 | −0.1 |
| Example 14 | 94.7 | 94.9 | 94.9 | 94.4 | 93.8 | 91.7 | −3.0 |

TABLE 3

| Example | Sheet a* at Age (wk) | | | | | | |
|---|---|---|---|---|---|---|---|
| (weeks) | 2.0 | 4.0 | 6.0 | 8.0 | 10.0 | 15.0 | Change |
| Comparative | 0.6 | 0.6 | 0.6 | 0.8 | 1.0 | 1.6 | +1.0 |
| Example 2 | | | | | | | |
| Comparative | 0.0 | 0.0 | 0.1 | 0.1 | 0.1 | 0.1 | +0.1 |
| Example 3 | | | | | | | |
| Example 8 | 0.6 | 0.5 | 0.5 | 0.6 | 0.7 | 0.8 | +0.2 |
| Example 9 | 0.3 | 0.3 | 0.3 | 0.4 | 0.4 | 0.9 | +0.6 |
| Example 10 | 0.5 | 0.4 | 0.4 | 0.4 | 0.4 | 0.5 | 0.0 |
| Example 11 | 0.4 | 0.4 | 0.4 | 0.4 | 0.4 | 0.3 | −0.1 |
| Example 12 | 0.2 | 0.2 | 0.2 | 0.2 | 0.3 | 0.3 | +0.1 |
| Example 13 | 0.1 | 0.1 | 0.2 | 0.2 | 0.2 | 0.2 | +0.1 |
| Example 14 | 0.3 | 0.3 | 0.3 | 0.4 | 0.5 | 0.9 | +0.6 |

TABLE 4

| Example | Sheet b* at Age (wk) | | | | | | Relative |
|---|---|---|---|---|---|---|---|
| (weeks) | 2.0 | 4.0 | 6.0 | 8.0 | 10.0 | 15.0 | Increase |
| Comparative | 1.0 | 1.7 | 2.3 | 3.2 | 3.9 | 5.4 | +4.4 |
| Example 2 | | | | | | | |
| Comparative | 0.4 | 0.4 | 0.4 | 0.4 | 0.4 | 0.5 | +0.1 |
| Example 3 | | | | | | | |
| Example 8 | 0.4 | 0.4 | 0.5 | 0.6 | 0.7 | 1.1 | +0.7 |
| Example 9 | −0.4 | −0.3 | −0.3 | −0.2 | 0.0 | 1.5 | +1.9 |
| Example 10 | 0.7 | 0.7 | 0.8 | 0.8 | 0.8 | 0.9 | +0.2 |
| Example 11 | 0.6 | 0.6 | 0.7 | 0.6 | 0.6 | 0.5 | −0.1 |
| Example 12 | 0.5 | 0.5 | 0.5 | 0.4 | 0.5 | 0.6 | +0.1 |
| Example 13 | 0.3 | 0.3 | 0.4 | 0.4 | 0.4 | 0.4 | +0.1 |
| Example 14 | 0.9 | 0.8 | 1.0 | 1.6 | 2.3 | 4.3 | +3.4 |

### Table 5

Table 5 shows the oxygen scavenging results with Comparative Examples 2 and 3 and Examples 8-14 of the invention.

TABLE 5

| | Initial | | |
|---|---|---|---|
| | Oxygen | Oxygen | Oxygen |
| | Concentration | Concentration | Scavenged |
| | (ppb) | at 21 d (ppb) | (%) |
| Comparative | 11265 | 722 | 94 |
| Example 2 | | | |
| Example 8 | 10846 | 956 | 91 |
| Example 9 | 10609 | 1032 | 90 |
| Example 10 | 9755 | 516 | 95 |
| Example 11 | 10390 | 288 | 97 |
| Example 12 | 10901 | 6079 | 44 |
| Example 13 | 12073 | 10677 | 11 |
| Example 14 | 10271 | 720 | 93 |
| Comparative | 10855 | 11086 | −2 |
| Example 3 | | | |

### Table 6

Table 6 shows the sheet haze measured over time. Relative increase is the ratio of haze at 15 week age to haze at 2 week age.

TABLE 6

| Example | Haze (%) at Age (wk) | | | | | | Relative |
|---|---|---|---|---|---|---|---|
| (weeks) | 2.0 | 4.0 | 6.0 | 8.0 | 10.0 | 15.0 | Increase |
| Comparative | 5.7 | 8.3 | 10.3 | 15.0 | 21.0 | 33.2 | 5.9 |
| Example 2 | | | | | | | |
| Comparative | 3.6 | 5.7 | 7.2 | 7.7 | 10.5 | 10.5 | 2.9 |
| Example 3 | | | | | | | |
| Example 8 | 8.5 | 9.4 | 9.7 | 11.3 | 14.8 | 16.7 | 2.0 |
| Example 9 | 26.3 | 26.2 | 26.1 | 29.6 | 32.8 | 56.6 | 2.2 |
| Example 10 | 8.0 | 8.8 | 8.4 | 11.3 | 14.5 | 17.3 | 2.2 |
| Example 11 | 11.2 | 10.8 | 11.4 | 12.2 | 15.3 | 15.0 | 1.3 |
| Example 12 | 4.7 | 4.6 | 5.9 | 6.8 | 9.1 | 11.2 | 2.4 |
| Example 13 | 3.8 | 4.0 | 5.1 | 6.1 | 8.1 | 9.2 | 2.4 |
| Example 14 | 5.2 | 6.1 | 7.5 | 12.0 | 16.4 | 27.5 | 5.3 |

The sheet samples of Comparative Examples 2 and 3 and Examples 7-12 were aged at 23° C. and 50% RH in an environmental chamber and the sheet haze was measured periodically over time from the middle point of the sheet. Table 3 provides the sheet haze data over time and the relative increase in haze from 2 weeks to 15 weeks. Comparative Example 2 shows a relative increase in haze of 5.9. Examples 8-13 show relative increase values of 1.3 to 2.4, indicating a significant improvement from Comparative Example 2. Example 14 shows a relative increase of 5.3, similar to Comparative Example 2. Example 9 has significantly higher initial haze than the other examples and is therefore not preferred. As shown above in Table 6, Examples 12 and 13 are inferior to the other examples in oxygen scavenging capability, and are therefore not preferred. Thus, Examples 8, 10, and 11 are the preferred embodiments of the invention.

As indicated in Tables 2, 3, 4, and 6 there is a correlation between the change in color and the change in haze. The measured color changes as the haze changes due to optical effects.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. An composition, comprising:
a polyester; and
a poly(alkylene oxide) glycol.

2. The composition according to claim 1, wherein the polyester is polyethylene terephthalate (PET).

3. The composition according to claim 1, wherein the poly(alkylene oxide) glycol is polytetramethylene ether glycol (PTMEG).

4. The composition according to claim 1, wherein the oxygen scavenging composition contains between about 55 wt. % to about 58 wt. % poly(alkylene oxide) glycol.

5. The composition according to claim 1, wherein the number average molecular weight of the poly(alkylene oxide) glycol is between about 1,000 g/mol to about 650 g/mol.

6. An oxygen scavenging composition comprising:
a polyester-poly(alkylene oxide) glycol copolymer; and
a polyethylene terephthalate copolymer, comprising
polyethylene terephthalate and a transition metal oxidation catalyst.

7. The oxygen scavenging composition according to claim 6, wherein the polyester of the composition is a polyethylene terephthalate (PET).

8. The oxygen scavenging composition according to claim 6, wherein the poly(alkylene oxide) glycol is polytetramethylene ether glycol (PTMEG).

9. The oxygen scavenging composition according to claim 8, wherein the composition contains between about 55 wt. % to about 58 wt. % polytetramethylene ether glycol (PTMEG).

10. The oxygen scavenging composition according to claim 9, wherein the number average molecular weight of the polytetramethylene ether glycol (PTMEG) is between about 1,000 g/mol to about 650 g/mol.

11. The oxygen scavenging composition according to claim 8, wherein the transition metal oxidation catalyst is selected from the group comprising cobalt acetate, cobalt carbonate, cobalt chloride, cobalt hydroxide, cobalt naphthenate, cobalt oleate, cobalt linoleate, cobalt octoate, cobalt stearate, cobalt nitrate, cobalt phosphate, cobalt sulfate, cobalt (ethylene glycolate), and mixtures thereof.

12. An article made from the oxygen scavenging composition of claim 8, where the article is a sheet.

13. An article made from the oxygen scavenging composition of claim 8, where the article is a thermoformed tray.

14. The article made from the oxygen scavenging composition of claim 13, wherein the oxygen scavenged is above 85% after 21 days

15. The article made from the oxygen scavenging composition of claim 13, wherein the relative increase in haze after 15 weeks is less than 2.4.

16. A method of producing an oxygen scavenging composition, comprising polymerizing polytetramethylene ether glycol (PTMEG) with a polyethylene terephthalate monomer (PET) forming a PET-PTMEG copolymer; and
blending the oxygen scavenging composition with a polyethylene terephthalate copolymer, comprising:
polyethylene terephthalate and a transition metal oxidation catalyst.

17. The method of producing an oxygen scavenging composition according to claim 16, wherein between about 55 wt. % to about 58 wt. % PTMEG is polymerized with the PET forming the PET-PTMEG copolymer.

18. The method of producing an oxygen scavenging composition according to claim 16, wherein the number average molecular weight of the PTMEG is between about 1,000 g/mol to about 650 g/mol.

19. A method of producing an article from an oxygen scavenging composition, comprising
(a) providing an extruder;
(b) polymerizing a polytetramethylene ether glycol (PTMEG) with a polyethylene terephthalate monomer (PET) forming a PET-PTMEG copolymer;
(c) blending the PET-PTMEG copolymer with a polyethylene terephthalate copolymer, comprising:
polyethylene terephthalate and a transition metal oxidation catalyst forming an oxygen scavenging composition;
(d) feeding the oxygen scavenging composition to the extruder, forming a sheet.

20. The method of producing an article from an oxygen scavenging composition according to claim 19, wherein between about 55 wt. % to about 58 wt. % PTMEG is polymerized with the PET and the number average molecular weight of the PTMEG is optionally between about 1,000 g/mol to about 650 g/mol.
